(19) United States
(12) Patent Application Publication
(10) Pub. No.: US 2024/0201502 A1
(43) Pub. Date: Jun. 20, 2024

(54) WEARABLE TERMINAL DEVICE, PROGRAM, AND DISPLAY METHOD

(71) Applicant: KYOCERA Corporation, Kyoto (JP)

(72) Inventors: Shingo ITO, Kyoto-shi, Kyoto (JP); Tomokazu ADACHI, Yokohama-shi, Kanagawa (JP); Kai SHIMIZU, Yokohama-shi, Kanagawa (JP)

(73) Assignee: KYOCERA Corporation, Kyoto (JP)

(21) Appl. No.: 18/551,857

(22) PCT Filed: Mar. 25, 2021
(86) PCT No.: PCT/JP2021/012570

§ 371 Date: Sep. 21, 2023

(51) Int. Cl. G02B 27/01; G06F 3/01; G06F 3/0482

(52) U.S. Cl. CPC G02B 27/0172; G06F 3/017; G06F 3/0482; G02B 2027/0138; G02B 2027/0141; G02B 2027/0196

(57) ABSTRACT

A wearable terminal device is configured to be used by being worn by a user. The wearable terminal device includes at least one processor. The at least one processor causes a display to display a virtual image located inside a space and having a first surface and a second surface on an opposite side from the first surface. The first surface of the virtual image has a first region and a strip-shaped second region that is smaller than the first region, and the second surface of the virtual image has a third region that is larger than the second region. The at least one processor causes a display mode of the virtual image to change to a prescribed display mode in response to a prescribed operation performed on the third region.

### TECHNICAL FIELD

The present disclosure relates to a wearable terminal device, a program, and a display method.

### BACKGROUND OF INVENTION

Heretofore, virtual reality (VR), mixed reality (MR), and augmented reality (AR) are known technologies that allow a user to experience virtual images and/or virtual spaces by using a wearable terminal device that is worn on the head of the user. A wearable terminal device includes a display that covers the field of view of the user when worn by the user. Virtual images and/or virtual spaces are displayed on this display in accordance with the position and orientation of the user in order to achieve a visual effect in which the virtual images and/or virtual spaces appear to actually exist (for example, specification of U.S. Patent Application Publication No. 2019/0087021 and specification of U.S. Patent Application Publication No. 2019/0340822).

MR is a technology that allows users to experience a mixed reality in which a real space and virtual images are merged together by displaying virtual images that appear to exist at prescribed positions in the real space while the user sees the real space. VR is a technology that allows a user to feel as though he or she is in a virtual space by allowing him or her to see a virtual space instead of a real space in MR.

Virtual images displayed in VR and MR have display positions defined in the space in which the user is located, and the virtual images are displayed on the display and are visible to the user when the display positions are within a visible area for the user.

### SUMMARY

A wearable terminal device of the present disclosure is configured to be used by being worn by a user. The wearable terminal device includes at least one processor. The at least one processor causes a display to display a virtual image located inside a space and having a first surface and a second surface on an opposite side from the first surface. The first surface of the virtual image has a first region and a strip-shaped second region that is smaller than the first region, and the second surface of the virtual image has a third region that is larger than the second region. The at least one processor causes a display mode of the virtual image to change to a prescribed display mode in response to a prescribed operation performed on the third region.

A program of the present disclosure is configured to cause a computer to execute causing a display to display a virtual image located inside a space and having a first surface and a second surface on an opposite side from the first surface. The computer is provided in a wearable terminal device configured to be used by being worn by a user. The first surface of the virtual image has a first region and a strip-shaped second region that is smaller than the first region, and the second surface of the virtual image has a third region that is larger than the second region. The causing a display to display a virtual image includes changing a display mode of the virtual image to change to a prescribed display mode in response to a prescribed operation performed on the third region.

A display method of the present disclosure is a display method for use in a wearable terminal device configured to be used by being worn by a user. In the display method, a display is caused to display a virtual image located inside a space and having a first surface and a second surface on an opposite side from the first surface. The first surface of the virtual image has a first region and a strip-shaped second region that is smaller than the first region, and the second surface of the virtual image has a third region that is larger than the second region. In the display method, a display mode of the virtual image is caused to change to a prescribed display mode in response to a prescribed operation performed on the third region.

### BRIEF DESCRIPTION OF THE DRAWINGS

FIG. 1 is a schematic perspective view illustrating the configuration of a wearable terminal device according to a First Embodiment.

FIG. 2 illustrates an example of a visible area and a virtual image seen by a user wearing a wearable terminal device.

FIG. 3 is a diagram for explaining a visible area in space.

FIG. 4 is a block diagram illustrating the main functional configuration of the wearable terminal device.

FIG. 5 is a flowchart illustrating the control procedure of virtual image display processing.

FIG. 6 is a diagram for explaining an operation for causing an image of a front surface to be displayed on the rear surface of a virtual image.

FIG. 7 is a diagram for explaining an operation for causing an image of a front surface to be displayed on the rear surface of a virtual image.

FIG. 8 is a diagram illustrating an example of a virtual image in which an image of a front surface is displayed on a rear surface.

FIG. 9 is a diagram for explaining an operation for causing an image of a front surface to be displayed on the rear surface of a virtual image.

FIG. 10 is a diagram illustrating an example of a virtual image in which an image of a front surface is displayed on a rear surface.

FIG. 11 is a diagram for explaining a turning motion carried out on a virtual image.

FIG. 12 is a diagram illustrating a display mode of a virtual image during a turning motion.

FIG. 13 is a diagram for explaining a turning motion carried out on a virtual image.

FIG. 14 is a diagram illustrating a display mode of a virtual image during a turning motion.

FIG. 15 is a diagram illustrating an example of a virtual image in which an image of a front surface is displayed on a rear surface.

FIG. 16 is a schematic diagram illustrating the configuration of a display system according to a Second Embodiment.

FIG. 17 is a block diagram illustrating the main functional configuration of an information processing apparatus.

### DESCRIPTION OF EMBODIMENTS

Hereafter, embodiments will be described based on the drawings. However, for convenience of explanation, each figure referred to below is a simplified illustration of only the main components that are needed in order to describe the embodiments. Therefore, a wearable terminal device 10 and an information processing apparatus 20 of the present disclosure may include any components not illustrated in the referenced figures.

### First Embodiment

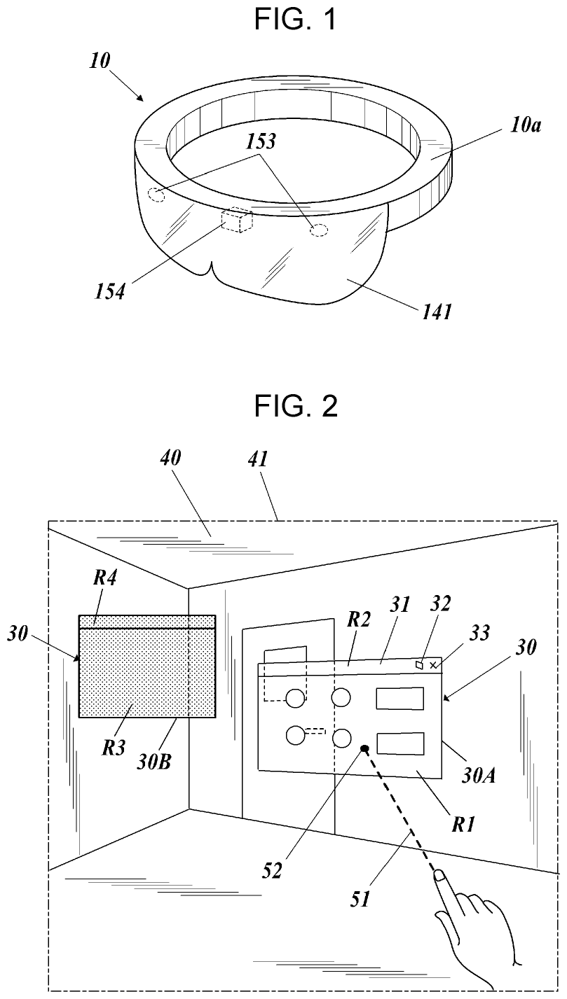

As illustrated in FIG. 1, the wearable terminal device 10 includes a body 10a and a visor 141 (display member) attached to the body 10a.

The body 10a is a ring-shaped member whose circumference can be adjusted. Various devices, such as a depth sensor 153 and a camera 154, are built into the body 10a. When the body 10a is worn on the user's head, the user's field of view is covered by the visor 141.

The visor 141 is transparent to light. The user can see a real space through the visor 141. An image such as a virtual image is projected and displayed on a display surface of the visor 141, which faces the user's eyes, from a laser scanner 142 (refer to FIG. 4), which is built into the body 10a. The user sees the virtual image in the form of light reflected from the display surface. At this time, since the user is also viewing the real space through the visor 141, a visual effect is obtained as though the virtual image exists in the real space.

As illustrated in FIG. 2, with virtual images 30 displayed, the user sees the virtual images 30 at prescribed positions in a space 40 with the virtual images 30 facing in prescribed directions. In this embodiment, the space 40 is the real space that the user sees through the visor 141. The virtual images 30 are projected onto a light-transmissive visor 141 so as to be seen as translucent images superimposed on the real space.

Note that, in the following description, the virtual images 30 are assumed to be flat window screens. Each virtual image 30 has a front surface 30A as a first surface and a rear surface 30B as a second surface. The front surface 30A has a first region R1 as a main region and a strip-shaped second region R2 that is smaller than the first region R1. The rear surface 30B has a third region R3 (corresponding to the first region R1) that is larger than the second region R2 and a fourth region R4 corresponding to the second region R2. Necessary information is displayed on the front surface 30A of the virtual image 30, and usually no information is displayed on the rear surface 30B of the virtual image 30.

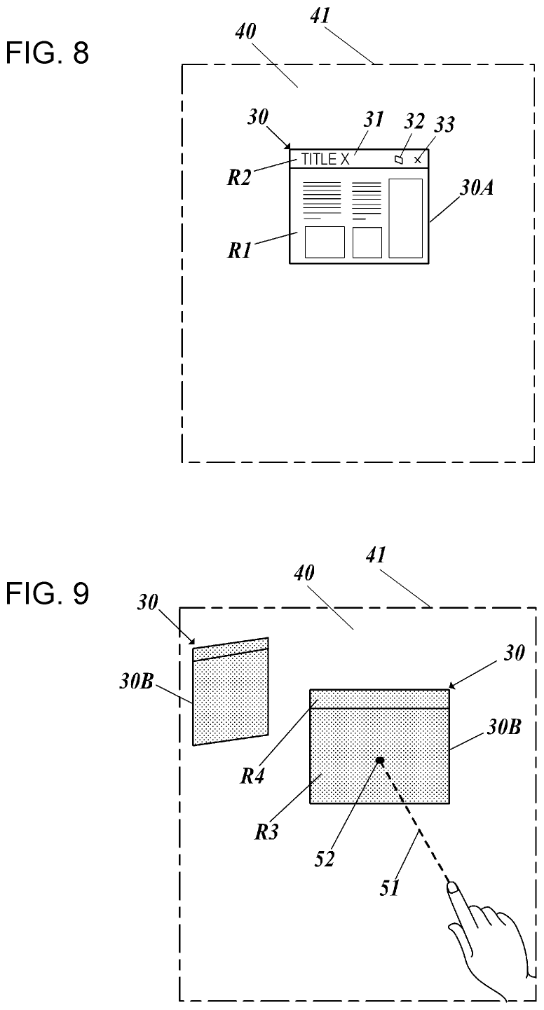

The second region R2 is a region in which a function bar 31 is displayed. The function bar 31 is a so-called title bar, but may instead be, for example, a toolbar, a menu bar, a scroll bar, a language bar, a task bar, a status bar, and so on. The second region R2 is also a region in which a title related to the contents displayed in the first region R1 (refer to FIG. 8) is displayed, as well as icons such as a window shape change button 32 and a close button 33.

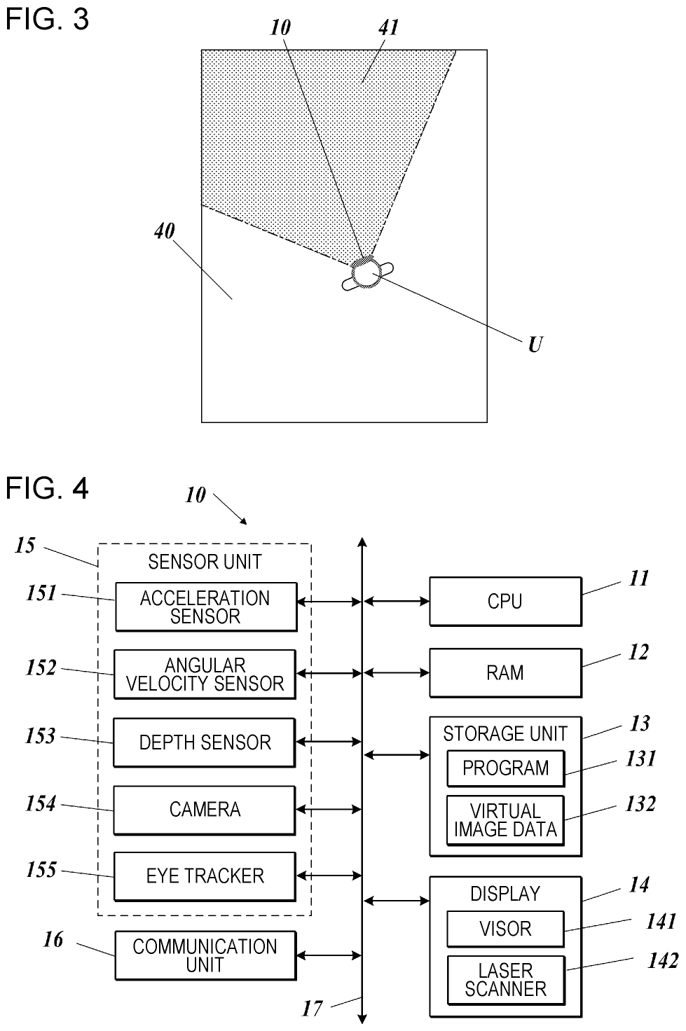

The wearable terminal device 10 detects a visible area 41 for the user based on the position and orientation of the user in the space 40 (in other words, the position and orientation of the wearable terminal device 10). As illustrated in FIG. 3, the visible area 41 is the area of the space 40 that is located in front of a user U wearing the wearable terminal device 10. For example, the visible area 41 is an area within a prescribed angular range from the front of user U in the left-right directions and up-down directions. In this case, a cross section obtained when a three-dimensional object corresponding to the shape of the visible area 41 is cut along a plane perpendicular to the frontal direction of the user U is rectangular. The shape of the visible area 41 may be defined so that the cross section has a shape other than a rectangular shape (for example, a circular or oval shape). The shape of the visible area 41 (for example, the angular range from the front in left-right directions and up-down directions) can be specified for example using the following method.

In the wearable terminal device 10, the field of view is adjusted (hereinafter referred to as “calibrated”) in a prescribed procedure at a prescribed timing, such as when the device is first started up. In this calibration, the area that can be seen by the user identified, and the virtual images 30 are displayed within that area thereafter. The shape of the visible area 41 can be set as the shape of the visible area identified by this calibration.

Calibration is not limited to being performed using the prescribed procedure described above, and calibration may be performed automatically during normal operation of the wearable terminal device 10. For example, if the user does not react to a display that the user is supposed to react to, the field of view (and the shape of the visible area 41) may be adjusted while assuming that the area where the display is performed is outside the user's field of view. The field of view (and the shape of the visible area 41) may be adjusted by performing display on a trial basis at a position that is defined as being outside the range of the field of view, and if the user does react to the display, the area where the display is performed may be considered as being within the range of the user's field of view.

The shape of the visible area 41 may be determined in advance and fixed at the time of shipment or the like and not based on the result of adjustment of the field of view. For example, the shape of the visible area 41 may be defined by the optical design of a display 14 to the maximum extent possible.

The virtual images 30 are generated in accordance with prescribed operations performed by the user with display positions and orientations defined in the space 40. Out of the generated virtual images 30, the wearable terminal device 10 displays the virtual images 30 whose display positions are defined inside the visible area 41 by projecting the virtual images 30 onto the visor 141. In FIG. 2, the visible area 41 is represented by a chain line.

The display positions and orientations of the virtual images 30 on the visor 141 are updated in real time in accordance with changes in the visible area 41 for the user. In other words, the display positions and orientations of the virtual images 30 change in accordance with changes in the visible area 41 so that the user perceives that “the virtual images 30 are located within the space 40 at set positions and with set orientations”. For example, as the user moves from the front sides to the rear sides of the virtual images 30, the shapes (angles) of the displayed virtual images 30 gradually change in accordance with this movement. When the user moves around to the rear side of a virtual image 30 and then faces the virtual image 30, the rear surface 30B of the virtual image 30 is displayed so that the user can see the rear surface 30B. In accordance with changes in the visible area 41, the virtual images 30 whose display positions have shifted out of the visible area 41 are no longer displayed, and if there are any virtual images 30 whose display positions have now entered the visible area 41, those virtual images 30 are newly displayed.

As illustrated in FIG. 2, when the user holds his or her hand (or finger) forward, the direction in which the hand is extended is detected by the wearable terminal device 10, and a virtual line 51 extending in that direction and a pointer 52 are displayed on the display surface of the visor 141 for the user to see. The pointer 52 is displayed at the intersection of the virtual line 51 and a virtual image 30. If the virtual line 51 does not intersect any virtual image 30, the pointer 52 may be displayed at the intersection of the virtual line 51 and a wall of the space 40 or the like. When the distance between the hand of the user and the virtual image 30 is within a prescribed reference distance, the pointer 52 may be directly displayed at a position corresponding to a finger tip of the user without displaying the virtual line 51 (refer to FIG. 7).

The user can adjust the direction of the virtual line 51 and the position of the pointer 52 by changing the direction in which the user extends his or her hand. When a prescribed gesture is performed with the pointer 52 adjusted so as to be positioned at a prescribed operation target (for example, the function bar 31, the window shape change button 32, or the close button 33) included in the virtual image 30, the gesture can be detected by the wearable terminal device 10 and a prescribed operation can be performed on the operation target. For example, with the pointer 52 aligned with the close button 33, the virtual image 30 can be closed (deleted) by performing a gesture for selecting an operation target (for example, a pinching gesture made using the fingertips). The virtual image 30 can be moved in the depth direction and in left-right directions by making a selection gesture with the pointer 52 aligned with the function bar 31, and then making a gesture of moving the hand back and forth and left and right while maintaining the selection gesture. Operations that can be performed on the virtual images 30 are not limited to these examples.

Thus, the wearable terminal device 10 of this embodiment can realize a visual effect as though the virtual images 30 exist in the real space, and can accept user operations performed on the virtual images 30 and reflect these operations in the display of the virtual images 30. In other words, the wearable terminal device 10 of this embodiment provides MR.

Next, the functional configuration of the wearable terminal device 10 will be described while referring to FIG. 4. The wearable terminal device 10 includes a central processing unit (CPU) 11, a random access memory (RAM) 12, a storage unit 13, the display 14, a sensor unit 15, and a communication unit 16, and these components are connected to each other by a bus 17. Each of the components illustrated in FIG. 4, except for the visor 141 of the display 14, is built into the body 10a and operates with power supplied from a battery, which is also built into the body 10a.

The CPU 11 is a processor that performs various arithmetic operations and performs overall control of the operations of the various parts of the wearable terminal device 10. The CPU 11 reads out and executes a program 131 stored in storage unit 13 in order to perform various control operations. The CPU 11 executes the program 131 in order to perform, for example, visible area detection processing and display control processing. Among these processing operations, the visible area detection processing is processing for detecting the visible area 41 for the user inside the space 40. The display control processing is processing for causing the display 14 to display the virtual images 30 whose positions are defined inside the visible area 41 from among the virtual images 30 whose positions are defined in the space 40.

A single CPU 11 is illustrated in FIG. 4, but the configuration is not limited to a single CPU 11. Two or more processors, such as CPUs, may be provided, and these two or more processors may share the processing performed by the CPU 11 in this embodiment.

The RAM 12 provides a working memory space for the CPU 11 and stores temporary data.

The storage unit 13 is a non-transitory recording medium that can be read by the CPU 11 serving as a computer. The storage unit 13 stores the program 131 executed by the CPU 11 and various settings data. The program 131 is stored in storage unit 13 in the form of computer-readable program code. For example, a nonvolatile storage device such as a solid state drive (SSD) including a flash memory can be used as the storage unit 13.

The data stored in storage unit 13 includes virtual image data 132 relating to virtual images 30. The virtual image data 132 includes data relating to display content of the virtual images 30 (for example, image data), display position data, and orientation data.

The display 14 includes the visor 141, the laser scanner 142, and an optical system that directs light output from the laser scanner 142 to the display surface of the visor 141. The laser scanner 142 irradiates the optical system with a pulsed laser beam, which is controlled so as to be switched on and off for each pixel, while scanning the beam in prescribed directions in accordance with a control signal from the CPU 11. The laser light incident on the optical system forms a display screen composed of a two-dimensional pixel matrix on the display surface of the visor 141. The method employed by the laser scanner 142 is not particularly limited, but for example, a method in which the laser light is scanned by operating a mirror using micro electro mechanical systems (MEMS) can be used. The laser scanner 142 includes three light-emitting units that emit laser light in colors of RGB, for example. The display 14 can perform color display by projecting light from these light-emitting units onto the visor 141.

The sensor unit 15 includes an acceleration sensor 151, an angular velocity sensor 152, the depth sensor 153, the camera 154, and an eye tracker 155. The sensor unit 15 may further include sensors that are not illustrated in FIG. 4.

The acceleration sensor 151 detects the acceleration and outputs the detection results to the CPU 11. From the detection results produced by the acceleration sensor 151, translational motion of the wearable terminal device 10 in directions along three orthogonal axes can be detected.

The angular velocity sensor 152 (gyro sensor) detects the angular velocity and outputs the detection results to the CPU 11. The detection results produced by the angular velocity sensor 152 can be used to detect rotational motion of the wearable terminal device 10.

The depth sensor 153 is an infrared camera that detects the distance to a subject using the time of flight (ToF) method, and outputs the distance detection results to the CPU 11. The depth sensor 153 is provided on a front surface of the body 10a such that images of the visible area 41 can be captured. The entire space 40 can be three-dimensionally mapped (i.e., a three-dimensional structure can be acquired) by repeatedly performing measurements using the depth sensor 153 each time the position and orientation of the user change in the space 40 and then combining the results.

The camera 154 captures images of the space 40 using a group of RGB imaging elements, acquires color image data as results of the image capturing, and outputs the results to the CPU 11. The camera 154 is provided on the front surface of the body 10a so that images of the visible area 41 can be captured. The images output from the camera 154 are used to detect the position, orientation, and so on of the wearable terminal device 10, and are also transmitted from the communication unit 16 to an external device and used to display the visible area 41 for the user of the wearable terminal device 10 on the external device.

The eye tracker 155 detects the user's line of sight and outputs the detection results to the CPU 11. The method used for detecting the line of sight is not particularly limited, but for example, a method can be used in which an eye tracking camera is used to capture images of the reflection points of near-infrared light in the user's eyes, and the results of that image capturing and the images captured by the camera 154 are analyzed in order to identify a target being looked at by the user. Part of the configuration of the eye tracker 155 may be provided in or on a peripheral portion of the visor 141, for example.

The communication unit 16 is a communication module that includes an antenna, a modulation-demodulation circuit, and a signal processing circuit. The communication unit 16 transmits and receives data via wireless communication with external devices in accordance with a prescribed communication protocol.

In the wearable terminal device 10 having the above-described configuration, the CPU 11 performs the following control operations.

The CPU 11 performs three-dimensional mapping of the space 40 based on distance data to a subject input from the depth sensor 153. The CPU 11 repeats this three-dimensional mapping whenever the position and orientation of the user change, and updates the results each time. The CPU 11 also performs three-dimensional mapping for each connected space 40 serving as a unit. Therefore, when the user moves between multiple rooms that are partitioned from each other by walls and so on, the CPU 11 recognizes each room as a single space 40 and separately performs three-dimensional mapping for each room.

The CPU 11 detects the visible area 41 for the user in the space 40. In detail, the CPU 11 identifies the position and orientation of the user (wearable terminal device 10) in the space 40 based on detection results from the acceleration sensor 151, the angular velocity sensor 152, the depth sensor 153, the camera 154, and the eye tracker 155, and accumulated three-dimensional mapping results. The visible area 41 is then detected (identified) based on the identified position and orientation and the predetermined shape of the visible area 41. The CPU 11 continuously detects the position and orientation of the user in real time, and updates the visible area 41 in conjunction with changes in the position and orientation of the user. The visible area 41 may be detected using detection results from some of the components out of the acceleration sensor 151, the angular velocity sensor 152, the depth sensor 153, the camera 154, and the eye tracker 155.

The CPU 11 generates the virtual image data 132 relating to the virtual images 30 in accordance with operations performed by the user. In other words, upon detecting a prescribed operation (gesture) instructing generation of a virtual image 30, the CPU 11 identifies the display content (for example, image data), display position, and orientation of the virtual image, and generates virtual image data 132 including data representing these specific results.

The CPU 11 causes the display 14 to display the virtual images 30 whose display positions are defined inside the visible area 41. The CPU 11 identifies virtual images 30 whose display position are defined inside the visible area 41 based on information on the display position included in the virtual image data 132, and generates image data of the display screen to be displayed on the display 14 based on the positional relationship between the visible area 41 and the display positions of the identified virtual images 30 at that point in time. The CPU 11 causes the laser scanner 142 to perform a scanning operation based on this image data in order to form a display screen containing the identified virtual images 30 on the display surface of the visor 141. In other words, the CPU 11 causes the virtual images 30 to be displayed on the display surface of the visor 141 so that the virtual images 30 are visible in the space 40 seen through the visor 141. By continuously performing this display control processing, the CPU 11 updates the display contents displayed on the display 14 in real time so as to match the user's movements (changes in the visible area 41). If the wearable terminal device 10 is set up to continue holding the virtual image data 132 even after the wearable terminal device 10 is turned off, the next time the wearable terminal device 10 is turned on, the existing virtual image data 132 is read and if there are virtual images 30 located inside the visible area 41, these virtual images 30 are displayed on the display 14.

The virtual image data 132 may be generated based on instruction data acquiring from an external device via the communication unit 16, and virtual images 30 may be displayed based on this virtual image data 132. Alternatively, the virtual image data 132 itself may be acquired from an external device via the communication unit 16 and virtual images 30 may be displayed based on the virtual image data 132. For example, an image captured by the camera 154 of the wearable terminal device 10 may be displayed on an external device operated by a remote instructor, an instruction to display the virtual image 30 may be accepted from the external device, and the instructed virtual image 30 may be displayed on the display 14 of the wearable terminal device 10. This makes it possible, for example, for a remote instructor to instruct a user of the wearable terminal device 10 in how to perform a task by displaying a virtual image 30 illustrating the work to be performed in the vicinity of a work object.

The CPU 11 detects the position and orientation of the user's hand (and/or fingers) based on images captured by the depth sensor 153 and the camera 154, and causes the display 14 to display a virtual line 51 extending in the detected direction and the pointer 52. The CPU 11 detects a gesture made by the user's hand (and/or fingers) based on images captured by the depth sensor 153 and the camera 154, and performs processing in accordance with the content of the detected gesture and the position of the pointer 52 at that time.

Next, operation of the wearable terminal device 10 when there is a virtual image 30 inside the visible area 41 with the front surface 30A not visible, i.e., with the rear surface 30B facing in a direction towards the user will be described.

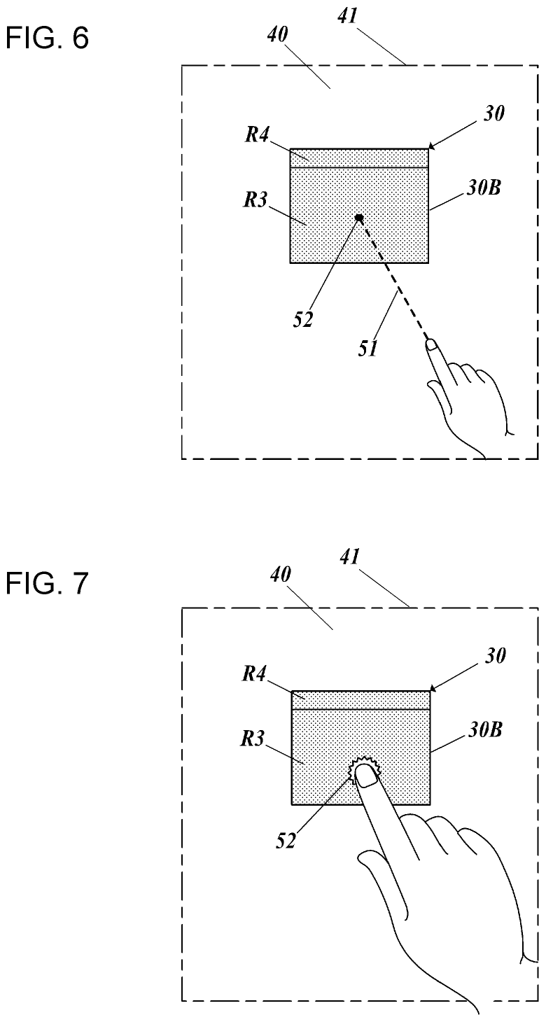

As described above, since there is usually no information displayed on the rear surface 30B of the virtual image 30, if the virtual image 30 is displayed inside the visible area 41 with the front surface 30A unable to be seen, the user will be unable to recognize what is illustrated in this virtual image 30. Therefore, the user would need to move around to the front side of the virtual image 30 when attempting to check the information displayed on the front surface 30A of the virtual image 30, which would be inconvenient. Therefore, heretofore, with the objective of allowing information displayed on the front surface 30A to be viewed without needing to move around to the front side of the virtual image 30, a technology has been disclosed for flipping the front surface 30A and the rear surface 30B of the virtual image 30 by making a prescribed gesture with the pointer 52 aligned with the fourth region R4 of the rear surface 30B (corresponding to the second region R2 of the front surface 30A) (refer to FIG. 6) of the virtual image 30. However, in this technology, the fourth region R4 is small and aligning the pointer 52 with the fourth region R4 is difficult, and therefore there is an issue in that performing an operation in order to flip the front surface 30A and the rear surface 30B of the virtual image 30 as described above is difficult. In particular, if the virtual image 30 is located at the far end of the visible area 41, the virtual image 30 is smaller in size, and the above issue becomes more pronounced.

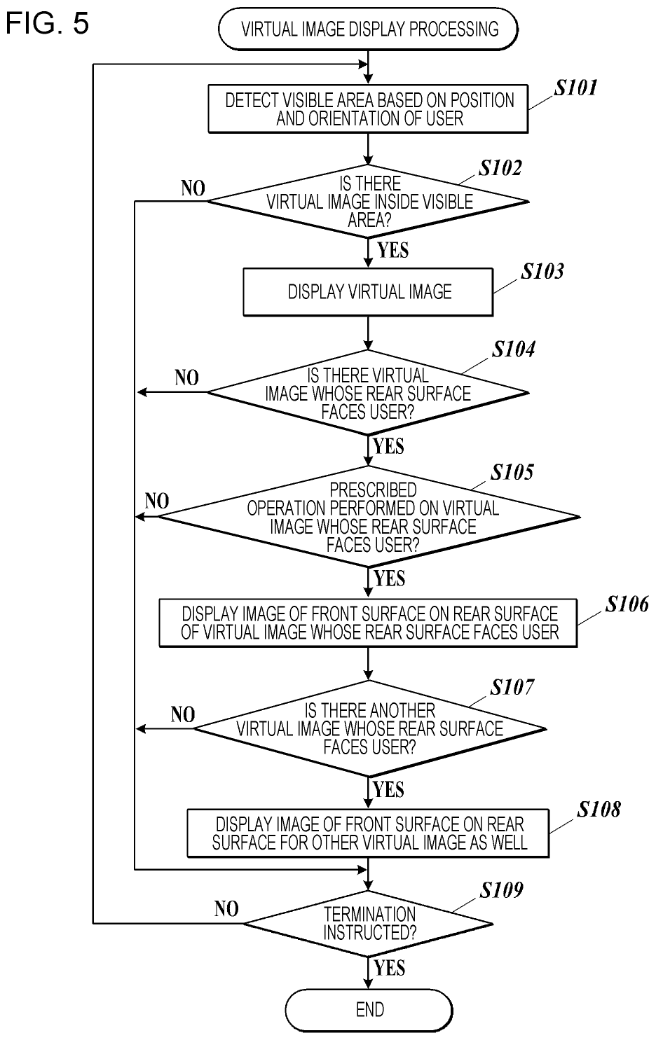

Therefore, the CPU 11 of the wearable terminal device 10 of this embodiment causes an image of the front surface 30A to be displayed on the rear surface 30B of the virtual image 30 in response to a prescribed operation performed on the third region R3 of the rear surface 30B of the virtual image 30. In this way, an operation for causing an image of the front surface 30A to be displayed on the rear surface 30B of the virtual image 30 can be made easier to perform. Next, an example of an operation for causing an image of the front surface 30A to be displayed on the rear surface 30B of the virtual image 30 will be described while referring to FIGS. 5 to 15.

First, a control procedure performed by the CPU 11 for virtual image display processing according to an aspect of the present disclosure will be described while referring to the flowchart in FIG. 5. The virtual image display processing in FIG. 5 at least includes a feature of causing an image of the front surface 30A to be displayed on the rear surface 30B of the virtual image 30 when a prescribed operation is performed on the third region R3 of the rear surface 30B of the virtual image 30.

When the virtual image display processing illustrated in FIG. 5 starts, the CPU 11 detects the visible area 41 based on the position and orientation of the user (Step S101).

Next, the CPU 11 determines whether or not there is a virtual image 30 whose display position is defined within the detected visible area 41 (Step S102).

When there is determined to be no virtual image 30 whose display position is defined within the detected visible area 41 in Step S102 (Step S102; NO), the CPU 11 advances the processing to Step S109.

When there is determined to be a virtual image 30 whose display position is defined within the detected visible area 41 in Step S102 (Step S102; YES), the CPU 11 causes the display 14 to display the virtual image 30 (Step S103).

Next, the CPU 11 determines whether or not there is a virtual image 30 whose rear surface 30B faces the user (virtual image 30 whose rear surface 30B faces in a direction toward user) among the virtual images 30 displayed on the display 14 (Step S104).

When there is determined to be no virtual image 30 whose rear surface 30B faces the user among the virtual images 30 displayed on the display 14 in Step S104 (Step S104; NO), the CPU 11 advances the processing to Step S109.

When there is determined to be a virtual image 30 whose rear surface 30B faces the user among the virtual images 30 displayed on the display 14 in Step S104 (Step S104; YES), the CPU 11 determines whether or not a prescribed operation has been performed on the virtual image 30 (Step S105).

As illustrated in FIG. 6, one method for realizing the above prescribed operation is as follows. A pointing operation is performed in which the pointer 52 displayed at the intersection of the virtual line 51 extending in the direction in which the user extends his or her hand and the virtual image 30 with the rear surface 30B facing the user is adjusted so as to be positioned in the third region R3, which is the target of the operation. While performing this pointing operation, the user makes a gesture to select this third region R3 (for example, a finger bending gesture), and then makes a gesture to move his or her hand (for example, moves to the left or right) while continuing to make the selection. As another method, when the distance between the user's hand and the virtual image 30 is within a prescribed reference distance, as illustrated in FIG. 7, the user performs a pointing operation in which the pointer 52, which is displayed at a position corresponding to the position of the user's fingertip, is adjusted so as to be positioned in the third region R3, which is the target of the operation, and the user then makes a gesture to select the third region R3 (for example, a finger bending gesture), and then makes a gesture to move his or her hand (for example, moves to the left or right) while continuing to make the selection. Thus, occurrence of erroneous operations can be suppressed by including the pointing operation and the selecting gesture (selection operation) in an operation for displaying an image of the front surface 30A on the rear surface 30B of the virtual image 30.

The prescribed operation may be performed as a series of operations up to the gesture for selecting the third region R3. In such a case, an image of the front surface 30A is displayed on the rear surface 30B of the virtual image 30 by making the gesture to select the third region R3 while the pointer 52 is aligned with the third region R3. The gesture for selecting the third region R3 is not limited to a finger bending gesture, and may be, for example, a pinching gesture made using the fingertips or a clenching gesture using their fist. The gesture of moving the hand is not limited to a gesture of moving the hand left or right, and may be, for example, a gesture of moving the hand up and down or back and forth, a gesture of turning the palm down (pronation), or a gesture of turning the palm up (supination). The gesture of moving the hand may be a turning motion that mimics the action of turning a piece of paper. This turning motion is described in detail below.

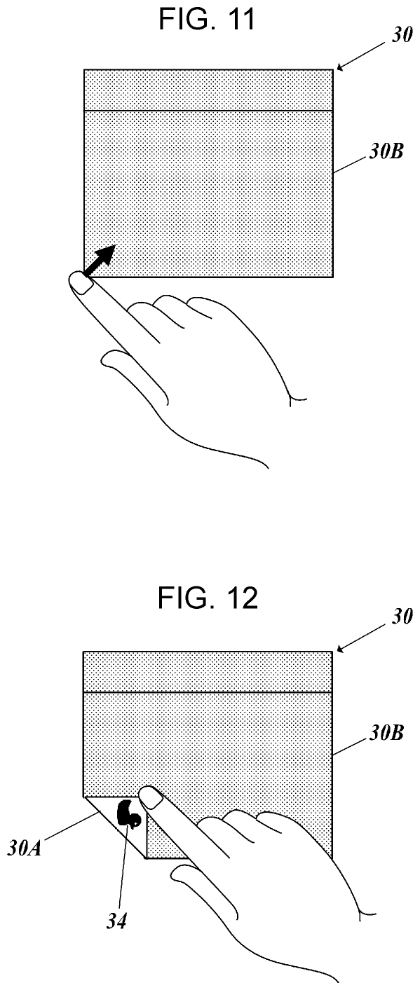

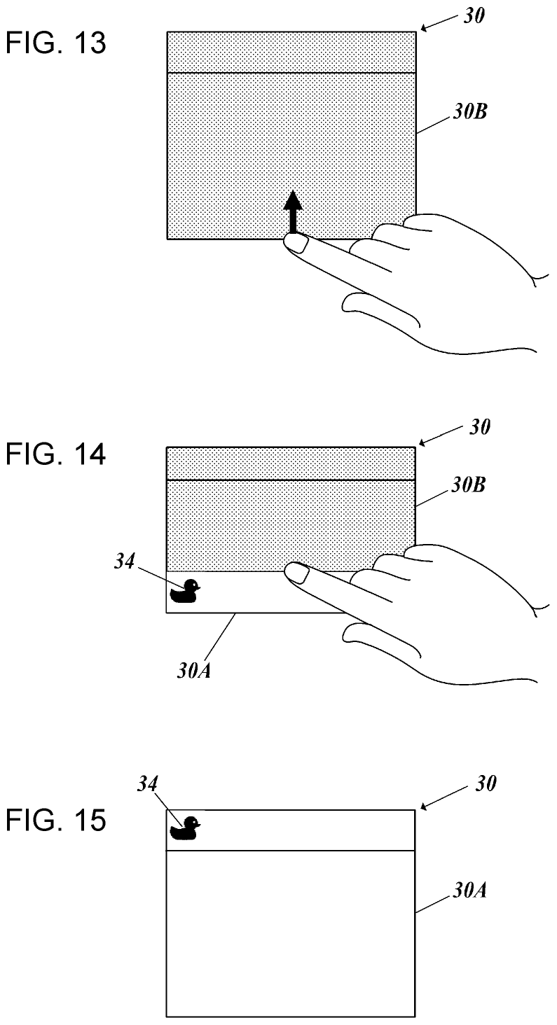

As illustrated in FIGS. 11 and 13, when a gesture of moving the hand is the above-described turning motion, the CPU 11 determines that a prescribed operation has been performed on the virtual image 30 when the distance moved by the hand in the turning motion is greater than or equal to a prescribed distance (YES in Step S105), and, as illustrated in FIG. 15, the CPU 11 causes an image of the front surface 30A to be displayed on the rear surface 30B of the virtual image 30 (Step 106; see below). On the other hand, when the distance moved by the hand in the turning motion is less than the prescribed distance, the CPU 11 determines that the prescribed operation has not been performed on the virtual image 30 (Step S105; NO).

In addition, up until the distance moved by the hand in the turning motion reaches the prescribed distance, the CPU 11 causes the virtual image 30 to be displayed such that, in accordance with the distance moved by the hand, the moving direction, and the starting position of the turning motion, part of the rear surface 30B is turned over in accordance with the moving distance, the moving direction, and the starting position of the turning motion, as illustrated in FIGS. 12 and 14, and part of the front surface 30A corresponding to the part of the rear surface 30B appears. The examples in FIG. 12 and FIG. 14 illustrate that an icon 34 located in the upper left corner of the front surface 30A (refer to FIG. 15) appears as a result of the turning motion.

If the turning motion is canceled before the distance moved by the hand in the turning motion reaches the prescribed distance, the CPU 11 causes the virtual image 30 to be displayed in a manner such that the entire rear surface 30B, as displayed before the turning motion is performed, appears.

The CPU 11 may determine that the prescribed operation has been performed on the virtual image 30 when the movement speed of the hand in the turning motion is greater than or equal to a prescribed speed (Step S105; YES), and may determine that the prescribed operation has not been performed on the virtual image 30 when the movement speed of the hand in the turning motion has not reached the prescribed speed (Step S105; NO). If a video is being played and displayed in the first region R1 of the front surface 30A of the virtual image 30, the CPU 11 may stop the playback display of the video while the turning motion is being performed. In this way, the video that is being played back and displayed in the first region R1 of the front surface 30A can be stopped from progressing while the turning motion of the virtual image 30 is being performed.

Returning to the description of the control procedure of the virtual image display processing, in Step S105, when the prescribed operation is determined not to have been performed on the virtual image 30 whose rear surface 30B faces the user (Step S105; NO), the CPU 11 advances the processing to Step S109.

In Step S105, when the prescribed operation is determined to have been performed on the virtual image 30 whose rear surface 30B faces the user (Step S105; YES), the CPU 11 causes an image of the front surface 30A to be displayed on the rear surface 30B of the virtual image 30 (Step 106). Specifically, as illustrated in FIGS. 6 and 7, when the above-described prescribed operation is determined to have been performed on the third region R3 of the virtual image 30, the CPU 11 causes an image of the front surface 30A to be displayed on the rear surface 30B of the virtual image 30, as illustrated in FIG. 8.

Next, the CPU 11 determines whether or not there is another virtual image 30 whose rear surface 30B faces the user (Step S107).

In Step S107, when there is determined to be no virtual image 30 whose rear surface 30B faces the user (Step S107; NO), the CPU 11 advances the processing to Step S109.

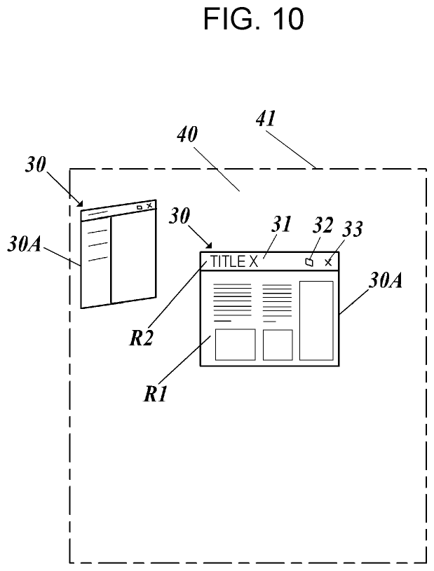

In Step S107, when there is determined to be another virtual image 30 whose rear surface 30B faces the user (Step S107; YES), the CPU 11 causes an image of the front surface 30A to be displayed on the rear surface 30B for this other virtual image 30 as well (Step 108). Specifically, if, as illustrated in FIG. 9, there is a virtual image 30 whose rear surface 30B is facing the user (the virtual image 30 at the upper left of the visible area 41) in addition to the virtual image 30 that is the target of the prescribed operation described above, the CPU 11 will cause an image of the front surface 30A to be displayed on the rear surface 30B for that virtual image 30 as well, as illustrated in FIG. 10.

Next, the CPU 11 determines whether or not an instruction has been issued to terminate the display operation performed by the wearable terminal device 10 (Step S109).

In Step S109, when no such instruction to terminate the display operation performed by the wearable terminal device 10 is determined to have been issued (Step S109; NO), the CPU 11 returns the processing to Step S101 and repeats the processing thereafter.

In Step S109, when such an instruction to terminate the display processing performed by the wearable terminal device 10 is determined to have been issued (Step S109; YES), the CPU 11 terminates the virtual image display processing.

### Second Embodiment

Next, the configuration of a display system 1 according to a Second Embodiment will be described. The Second Embodiment differs from the First Embodiment in that an external information processing apparatus 20 executes part of the processing that is executed by the CPU 11 of the wearable terminal device 10 in the First Embodiment. Hereafter, differences from the First Embodiment will be described, and description of common points will be omitted.

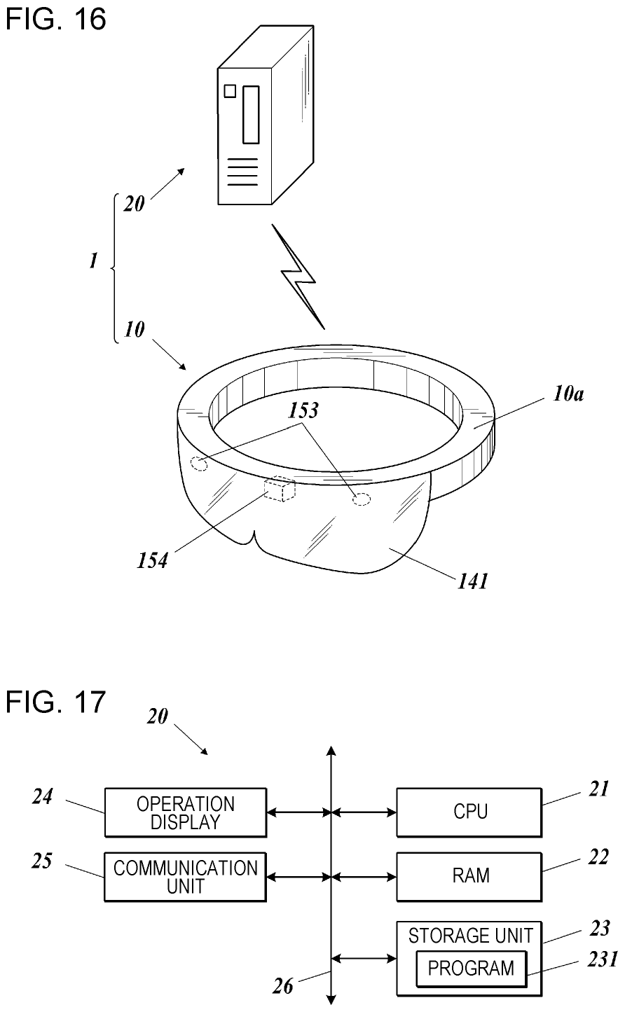

As illustrated in FIG. 16, the display system 1 includes the wearable terminal device 10 and the information processing apparatus 20 (server) connected to the wearable terminal device 10 so as to be able to communicate with the wearable terminal device 10. At least part of a communication path between the wearable terminal device 10 and the information processing apparatus 20 may be realized by wireless communication. The hardware configuration of the wearable terminal device 10 can be substantially the same as in the First Embodiment, but the processor for performing the same processing as that performed by the information processing apparatus 20 may be omitted.

As illustrated in FIG. 17, the information processing apparatus 20 includes a CPU 21, a RAM 22, a storage unit 23, an operation display 24, and a communication unit 25, which are connected to each other by a bus 26.

The CPU 21 is a processor that performs various arithmetic operations and controls overall operation of the various parts of the information processing apparatus 20. The CPU 21 reads out and executes a program 231 stored in storage unit 23 in order to perform various control operations.

The RAM 22 provides a working memory space for the CPU 21 and stores temporary data.

The storage unit 23 is a non-transitory recording medium that can be read by the CPU 21 serving as a computer. The storage unit 23 stores the program 231 executed by the CPU 21 and various settings data. The program 231 is stored in storage unit 23 in the form of computer-readable program code. For example, a nonvolatile storage device such as an SSD containing a flash memory or a hard disk drive (HDD) can be used as the storage unit 23.

The operation display 24 includes a display device such as a liquid crystal display and input devices such as a mouse and keyboard. The operation display 24 displays various information about the display system 1, such as operating status and processing results, on the display device. Here, the operating status of the display system 1 may include real-time images captured by the camera 154 of the wearable terminal device 10. The operation display 24 converts operations input to the input devices by the user into operation signals and outputs the operation signals to the CPU 21.

The communication unit 25 communicates with the wearable terminal device 10 and transmits data to and receives data from the wearable terminal device 10. For example, the communication unit 25 receives data including some or all of the detection results produced by the sensor unit 15 of the wearable terminal device 10 and information relating to user operations (gestures) detected by the wearable terminal device 10. The communication unit 25 may also be capable of communicating with devices other than the wearable terminal device 10.

In the thus-configured display system 1, the CPU 21 of the information processing apparatus 20 performs at least part of the processing that the CPU 11 of the wearable terminal device 10 performs in the First Embodiment. For example, the CPU 21 may perform three-dimensional mapping of the space 40 based on detection results from the depth sensor 153. The CPU 21 may detect the visible area 41 for the user in the space 40 based on detection results produced by each part of the sensor unit 15. The CPU 21 may also generate the virtual image data 132 relating to the virtual images 30 in accordance with operations performed by the user of the wearable terminal device 10. The CPU 21 may also detect the position and orientation of the user's hand (and/or fingers) based on images captured by the depth sensor 153 and the camera 154.

The results of the above processing performed by the CPU 21 are transmitted to wearable terminal device 10 via the communication unit 25. The CPU 11 of the wearable terminal device 10 causes the individual parts of the wearable terminal device 10 (for example, display 14) to operate based on the received processing results. The CPU 21 may also transmit control signals to the wearable terminal device 10 in order to control the display 14 of the wearable terminal device 10.

Thus, as a result of executing at least part of the processing in the information processing apparatus 20, the configuration of the wearable terminal device 10 can be simplified and manufacturing costs can be reduced. In addition, using the information processing apparatus 20, which has a higher performance, allows various types of processing related to MR to be made faster and more precise. Thus, the precision of 3D mapping of the space 40 can be increased, the quality of display performed by the display 14 can be improved, and the reaction speed of the display 14 to operations performed by the user can be increased.

### Other Considerations

The above embodiments are illustrative examples, and may be changed in various ways.

For example, in each of the above embodiments, the visor 141 that is transparent to light was used to allow the user to see the real space, but this configuration does not necessarily need to be adopted. For example, a visor 141 that blocks light may be used and the user may be allowed to see an image of the space 40 captured by the camera 154. In other words, the CPU 11 may cause the display 14 to display an image of the space 40 captured by the camera 154 and the virtual images 30 superimposed on the image of the space 40. With this configuration, MR, in which the virtual images 30 are merged with the real space, can be realized.

In addition, VR can be realized in which the user is made to feel as though he or she is in a virtual space by using images of a pre-generated virtual space instead of images captured in the real space by the camera 154. In this VR as well, the visible area 41 for the user is identified, and the virtual images 30 whose display positions are defined inside the visible area 41 out of the virtual space are displayed.

The wearable terminal device 10 does not need to include the ring-shaped body 10a illustrated in FIG. 1, and may have any structure so long as the wearable terminal device 10 includes a display that is visible to the user when worn. For example, a configuration in which the entire head is covered, such as a helmet, may be adopted. The wearable terminal device 10 may also include a frame that hangs over the ears, like a pair of glasses, with various devices built into the frame.

An example has been described in which the gestures of a user are detected and accepted as input operations, but the present disclosure is not limited to this example. For example, input operations may be accepted by a controller held in the user's hand or worn on the user's body.

Each virtual image 30 can be set to either a first mode in which an image of the front surface 30A can be displayed on the rear surface 30B based on the prescribed operation performed on the third region R3 of the virtual image 30 or a second mode in which the prescribed operation is disabled and an image of the front surface 30A cannot be displayed on the rear surface 30B. When the virtual images 30 are displayed on the display 14, the virtual images 30 set to the first mode and the virtual images 30 set to the second mode may be displayed so as to be distinguishable from each other. For example, the rear surfaces 30B of the virtual images 30 set to the first mode are displayed in blue, whereas the rear surfaces 30B of the virtual images 30 set to the second mode are displayed in red.

In the above embodiment, an image of the front surface 30A is made to be displayed on the rear surface 30B of a virtual image 30 by performing the above-described prescribed operation on the third region R3 of the rear surface 30B of the virtual image 30, but if, for example, information is displayed on both the front surface 30A and the rear surface 30B, an image of the rear surface 30B may be made to be displayed on the front surface 30A of the virtual image 30 by performing the above-described prescribed operation on the first region R1 of the front surface 30A of the virtual image 30.

By performing the above-described prescribed operation on the third region R3 of the rear surface 30B of the virtual image 30, the display mode of a virtual image 30 may be changed to a prescribed display mode, for example, the virtual image 30 may be enlarged (or reduced) to a prescribed size or the virtual image 30 may be rotated to a prescribed angle.

In the above embodiment, an example has been illustrated in which the front surface 30A of each virtual image 30 has the first region R1 as a main region and the strip-shaped second region R2, which is smaller than the first region R1, the rear surface 30B of each virtual image 30 has the third region R3 corresponding to the first region R1 as a region that is larger than the second region R2, and an image of the front surface 30A is displayed on the rear surface 30B in response to a prescribed operation being performed on the third region R3. However, the region that is larger than the second region R2 is not limited to the third region R3. The wearable terminal device 10 may cause an image of the front surface 30A to be displayed on the rear surface 30B in accordance with a prescribed operation performed on the third and fourth regions R3 and R4 of the rear surface 30B, i.e., the entire area of the rear surface 30B, as a region that is larger than the second region R2. In this case, the third region R3 and the fourth region R4 are not distinguished from each other and the rear surface 30B may consist of just a single region.

A case in which the third region R3, which is the region subjected to the prescribed operation in order to display an image of the front surface 30A on the rear surface 30B, corresponds to the first region R1 and is of the same size as the first region R1 has been described as an example, but this configuration does not need to be adopted. The third region R3 may be smaller than first region R1 so long as the third region R3 is larger than second region R2. The size of the fourth region R4 of the rear surface 30B corresponding to the second region R2 of the front surface 30A may be larger than the second region R2, and an image of the front surface 30A may be displayed on the rear surface 30B in response to a prescribed operation performed on the fourth region R4.

Other specific details of the configurations and control operations described in the above embodiments can be changed as appropriate without departing from the intent of the present disclosure. The configurations and control operations described in the above embodiments can be combined as appropriate to the extent that the resulting combinations do not depart from the intent of the present disclosure.

### INDUSTRIAL APPLICABILITY

The present disclosure can be used in wearable terminal devices, programs, and display methods.

### REFERENCE SIGNS

1 display system
10 wearable terminal device
10a body
11 CPU (processor)
12 RAM
13 storage unit
131 program
132 virtual image data
14 display
141 visor (display member)
142 laser scanner
15 sensor unit
151 acceleration sensor
152 angular velocity sensor
153 depth sensor
154 camera
155 eye tracker
16 communication unit
17 bus
20 information processing apparatus
21 CPU
22 RAM
23 storage unit
231 program
24 operation display
25 communication unit
26 bus
30 virtual image
30A front surface
30B rear surface
31 function bar
32 window shape change button
33 close button
34 icon
40 space
41 visible area
51 virtual line
52 pointer
R1 first region
R2 second region
R3 third region
R4 fourth region
U user

1. A wearable terminal device configured to be used by being worn by a user, the wearable terminal device comprising:
at least one processor,
wherein the at least one processor causes a display to display a virtual image located inside a space and having a first surface and a second surface on an opposite side from the first surface,
the first surface of the virtual image has a first region and a strip-shaped second region that is smaller than the first region, and the second surface of the virtual image has a third region that is larger than the second region, and
the at least one processor causes a display mode of the virtual image to change to a prescribed display mode in response to a prescribed operation performed on the third region.

2. The wearable terminal device according to claim 1,
wherein the display includes a display member that is transparent to light, and
the at least one processor causes the virtual image to be displayed on a display surface of the display member with the virtual image visible in the space that is visible through the display member.

3. The wearable terminal device according to claim 1, further comprising:
a camera configured to capture an image of the space,
wherein the at least one processor causes the display to display an image of the space captured by the camera and the virtual image superimposed on the image of the space.

4. The wearable terminal device according to claim 1,
wherein the second region is a region in which a function bar is displayed.

5. The wearable terminal device according to t claim 1,
wherein the second region is a region in which a title or an icon relating to display content of the first region is displayed.

6. The wearable terminal device according to claim 1,
is a plurality of the virtual images on which the prescribed operation can be performed displayed on the display, in response to the prescribed operation being performed on one of the plurality of virtual images, the at least one processor changes a display mode of another one of the virtual images to the prescribed display mode.

7. The wearable terminal device according claim 1,
wherein the prescribed operation includes a pointing operation in which an intersection between a virtual line displayed in a direction in which a hand of the user extends and the virtual image is specified as a specified position in the virtual image.

8. The wearable terminal device according to claim 1,
wherein the prescribed operation includes a pointing operation in which a location where a position of a finger of the user in a real space overlaps the virtual image is specified as a specified position in the virtual image.

9. The wearable terminal device according to claim 7,
wherein the prescribed operation includes a selection operation in which the specified position specified by the pointing operation is selected.

10. The wearable terminal device according to claim 9,
wherein the at least one processor causes an image of the first surface to be displayed on the second surface of the virtual image in response to the prescribed operation.

11. The wearable terminal device according to claim 9,
wherein the prescribed operation further includes a prescribed movement of a hand of the user made while the pointing operation and the selection operation are performed, and
the at least one processor causes an image of the first surface to be displayed on the second surface of the virtual image in response to the prescribed operation.

12. The wearable terminal device according to claim 11,
wherein the prescribed movement of the hand of the user is a turning motion mimicking an action of turning a piece of paper.

13. The wearable terminal device according to claim 12,
wherein the at least one processor causes an image of the first surface to be displayed on the second surface of the virtual image when a movement speed of the hand of the user in the turning motion is greater than or equal to a prescribed speed.

14. The wearable terminal device according to claim 12,
wherein the at least one processor causes an image of the first surface to be displayed on the second surface of the virtual image when a movement distance of the hand of the user in the turning motion is greater than or equal to a prescribed distance.

15. The wearable terminal device according to claim 14,
wherein the at least one processor causes the virtual image to be displayed in a manner in which a portion of the first surface corresponding to a portion of the second surface appears as a result of the portion of the second surface being turned over in accordance with a distance moved by the hand of the user in a period until the distance moved by the hand of the user reaches the prescribed distance in the turning motion.

16. The wearable terminal device according to claim 15,
wherein the at least one processor causes the virtual image to be displayed in a manner in which all of the second surface prior to the turning motion appears when the turning motion is canceled before the distance moved by the hand of the user in the turning motion reaches the prescribed distance.

17. The wearable terminal device according to claim 12,
wherein when a video is being played back and displayed in the first region of the virtual image, the at least one processor stops playback display of the video while the turning motion is being performed.

18. The wearable terminal device according to claim 1,
wherein each virtual image can be set to either a first mode in which the virtual image can be changed to the prescribed display mode or a second mode in which the virtual image cannot be changed to the prescribed display mode, and
the at least one processor causes the virtual images set to the first mode and the virtual images set to the second mode to be displayed in a distinguishable manner when causing the display to display the virtual images.

19. A non-transitory computer-readable storage medium storing a program configured to cause a computer provided in a wearable terminal device configured to be used by being worn by a user to execute:
causing a display to display a virtual image located inside a space and having a first surface and a second surface on an opposite side from the first surface,
wherein the first surface of the virtual image has a first region and a strip-shaped second region that is smaller than the first region, and the second surface of the virtual image has a third region that is larger than the second region, and
the causing a display to display a virtual image includes causing a display mode of the virtual image to change to a prescribed display mode in response to a prescribed operation performed on the third region.

20. A display method for use in a wearable terminal device configured to be used by being worn by a user, the method comprising:
causing a display to display a virtual image located inside a space and having a first surface and a second surface on an opposite side from the first surface,
wherein the first surface of the virtual image has a first region and a strip-shaped second region that is smaller than the first region, and the second surface of the virtual image has a third region that is larger than the second region, and
in the causing a display to display a virtual image, a display mode of the virtual image is caused to change to a prescribed display mode in response to a prescribed operation performed on the third region.
